(19) United States
(12) Patent Application Publication
(10) Pub. No.: US 2025/0123906 A1
(43) Pub. Date: Apr. 17, 2025

(54) COMPILING AND GENERATING DISPLAY CONTENT FOR EVENTS IN A RECORD

(71) Applicant: Capital One Services, LLC, McLean, VA (US)

(72) Inventor: Kelly ZHANG, Chapel Hill, NC (US)

(21) Appl. No.: 18/488,608

(22) Filed: Oct. 17, 2023

(51) Int. Cl. G06F 9/54; G06F 9/451

(52) U.S. Cl. CPC G06F 9/542; G06F 9/451

(57) ABSTRACT

In some implementations, a device may monitor the account record, wherein the account record indicates a set of events associated with an account. The device may aggregate, based on monitoring the account record, one or more events from the set of events that satisfy one or more aggregation criteria, wherein the one or more events are identified based on account data associated with the account record and event data associated with the set of events. The device may generate, based on the event data, one or more groups of events, from the one or more events, indicating events associated with respective event parameters. The device may generate, for a group of events from the one or more groups of events, display content indicative of information associated with events included in the group of events. The device may provide the display content for display.

### BACKGROUND

A graphical user interface is a form of user interface that allows users to interact with electronic devices. A web browser or application may provide a graphical user interface that presents web pages. A user may navigate to a page by entering an address into an address bar of the web browser and/or by clicking a link displayed via another page. Navigation to a page may consume resources of a client device on which the browser or application is installed, may consume resources of a server that serves the page to the client device, and may consume network resources used for communications between the client device and the server.

### SUMMARY

Some implementations described herein relate to a system for compiling and generating display content for events in an account record. The system may include one or more memories and one or more processors communicatively coupled to the one or more memories. The one or more processors may be configured to identify, using a machine learning model, one or more events from a set of events included in the account record, wherein the one or more events are recurring non-subscription-based events, and wherein the one or more events are identified based on account data associated with the account record and event data associated with the set of events. The one or more processors may be configured to store, in a database and based on identifying the one or more events, an indication of the one or more events. The one or more processors may be configured to determine, for entities associated with respective events from the one or more events, one or more entity similarity scores indicating a similarity between two or more entities. The one or more processors may be configured to generate, based on the one or more entity similarity scores, one or more groups of events, from the one or more events, indicating events associated with similar entities. The one or more processors may be configured to generate, for a group of events from the one or more groups of events, display content indicative of information associated with events included in the group, wherein the display content is based on the information associated with the events included in the group and is based on the account data. The one or more processors may be configured to provide, for display in association with the account record, the display content.

Some implementations described herein relate to a method of compiling and generating display content for events in an account record. The method may include monitoring, by a device, the account record, wherein the account record indicates a set of events associated with an account. The method may include aggregating, by the device and based on monitoring the account record, one or more events from the set of events that satisfy one or more aggregation criteria, wherein the one or more events are identified based on account data associated with the account record and event data associated with the set of events. The method may include generating, by the device and based on the event data, one or more groups of events, from the one or more events, indicating events associated with respective event parameters. The method may include generating, by the device and for a group of events from the one or more groups of events, display content indicative of information associated with events included in the group of events, wherein the display content is based on the information associated with the events and is based on the account data. The method may include providing, by the device, the display content for display.

Some implementations described herein relate to a non-transitory computer-readable medium that stores a set of instructions. The set of instructions, when executed by one or more processors of a device, may cause the device to obtain an account record indicating a set of events associated with an account. The set of instructions, when executed by one or more processors of the device, may cause the device to aggregate, based on monitoring the account record, one or more events from the set of events based on the one or more events satisfying one or more aggregation criteria. The set of instructions, when executed by one or more processors of the device, may cause the device to generate one or more groups of events, from the one or more events, indicating events associated with respective event parameters. The set of instructions, when executed by one or more processors of the device, may cause the device to generate, for a group of events from the one or more groups of events, display content indicative of information associated with events included in the group of events, wherein the display content is based on the information associated with the events and is based on account data associated with the account record. The set of instructions, when executed by one or more processors of the device, may cause the device to provide the display content for display.

### BRIEF DESCRIPTION OF THE DRAWINGS

FIGS. 1A-1C are diagrams of an example associated with compiling and generating display content for events in a record, in accordance with some embodiments of the present disclosure.

FIG. 2 is a diagram illustrating an example of training and using a machine learning model in connection with compiling and generating display content for events in a record, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with compiling and generating display content for events in a record, in accordance with some embodiments of the present disclosure.

FIG. 5 is a flowchart of an example process associated with compiling and generating display content for events in a record, in accordance with some embodiments of the present disclosure.

### DETAILED DESCRIPTION

The following detailed description of example implementations refers to the accompanying drawings. The same reference numbers in different drawings may identify the same or similar elements.

A display of a client device may display a user interface (e.g., a graphical user interface). A user interface may permit interactions between a user of the client device and the client device. In some examples, the user may interact with the user interface to operate and/or control the client device to produce a desired result. For example, the user may interact with the client device to cause the client device to perform an action. Additionally, the user interface may provide information to the user.

A user interface of the client device, such as a user interface provided by a browser or application, may include a page for presentation via the client device. The page may include links or graphical elements that, when selected via a user input, cause the client device to navigate to various other pages. For example, a homepage, or a main page, may include links or graphical elements that, when selected via a user input, cause the client device to navigate to multiple sub-pages. Often, it may be difficult for a user to locate, via the homepage, particular information of interest that is included in a sub-page. For example, the link or graphical element descriptions on the homepage may be unintuitive and/or the user may need to click through links or graphical elements in multiple hierarchical levels of sub-pages in order to locate the information of interest. For example, if the user is trying to determine information associated with an account (e.g., associated with a record of the account), the user may navigate to a page associated with displaying the record and/or a summary of the record. However, the page may display information at a generic summary level and/or provide an overview of events associated with the account. The user may need to navigate to multiple pages to investigate and/or identify information associated with particular events, trends associated with the account, and/or other more insightful information associated with the account. Navigating through a large number of pages to find relevant information creates a poor user experience, consumes excessive computing resources (e.g., processing resources and memory resources) that are needed for the client device to generate and display the pages and that are needed for one or more server devices to serve the pages to the client device, and consumes excessive network resources that are needed for communications between the client device and the server device(s).

In some examples, the homepage may provide a search interface for locating information included in sub-pages. However, the search interface may operate based on keyword searching, which may be unhelpful if the user is not aware of particular keywords relevant to the information of interest. As a result, the user may need to perform multiple searches using various combinations of keywords, which may also create a poor user experience, consume excessive computing resources needed for executing the multiple searches and displaying the search results, and/or consume excessive network resources, among other examples. Moreover, search results are typically presented to the user on a separate page from the homepage, which may confuse the user, result in the user missing important information included on the homepage, and/or consume computing resources or network resources associated with loading and/or displaying the separate page.

Some implementations described herein enable compiling and generating display content for events in a record. In some implementations, a record management device may identify, using a machine learning model, one or more events from a set of events included in an account record. The one or more events may be recurring non-subscription-based events (e.g., events that occur frequently, but that are not associated with a set pattern or subscription). For example, the machine learning model may be configured to detect the recurring non-subscription-based events. The record management device may store, in a database and based on identifying the one or more events, an indication of the one or more events (e.g., the record management device may identify and separately store the recurring non-subscription-based events).

The record management device may determine, for entities associated with respective events from the one or more events, one or more entity similarity scores indicating a similarity between two or more entities. The record management device may generate, based on the one or more entity similarity scores, one or more groups of events, from the one or more events, indicating events associated with similar entities. The record management device may generate, for a group of events from the one or more groups of events, display content indicative of information associated with events included in the group. The display content may be based on the information associated with the events included in the group and is based on account data associated with the account. For example, the display content may be indicative of information associated with the events included in the group (e.g., may be indicative of trends, detection occurrences, or other information for the events included in the group). The display content may be associated with a content class. The content class may indicate a subtext, nuance, implicit or hidden semantic meaning, a tone, and/or an undertone, among other examples of the display content. The content class may be based on account data associated with the account. The record management device may provide, for display (e.g., in association with the account record), the display content (e.g., via a user interface that displays the account record). A client device may provide, for display, a user interface that indicates the account record and/or the display content.

As a result, display content that is indicative of underlying event patterns, trends, occurrences, or other insightful information may be displayed in connection with the account record. By generating display content for certain identified events indicated by the record (e.g., recurring non-subscription-based events), the user interface displaying the account record may provide more insightful and/or usable information for a user. Additionally, by generating display content have a given content class (e.g., a subtext, nuance, implicit or hidden semantic meaning, a tone, and/or an undertone), the user may be more likely to read, understand, and/or digest the display content. This enables the user to quickly locate informational content of interest for the account record without navigating away from a user interface associated with the account record and without interacting with numerous links or graphical elements from the user interface. In this way, processing resources, computing resources, and/or network resources may be conserved by reducing an amount of navigation performed by the user to obtain the informational content of interest (e.g., to obtain information indicated by the display content). Furthermore, the implementations described herein make data easier to access by enhancing information indicated via a user interface, thereby improving a user experience, and/or enhancing user-friendliness of a client device and the user interface, among other examples.

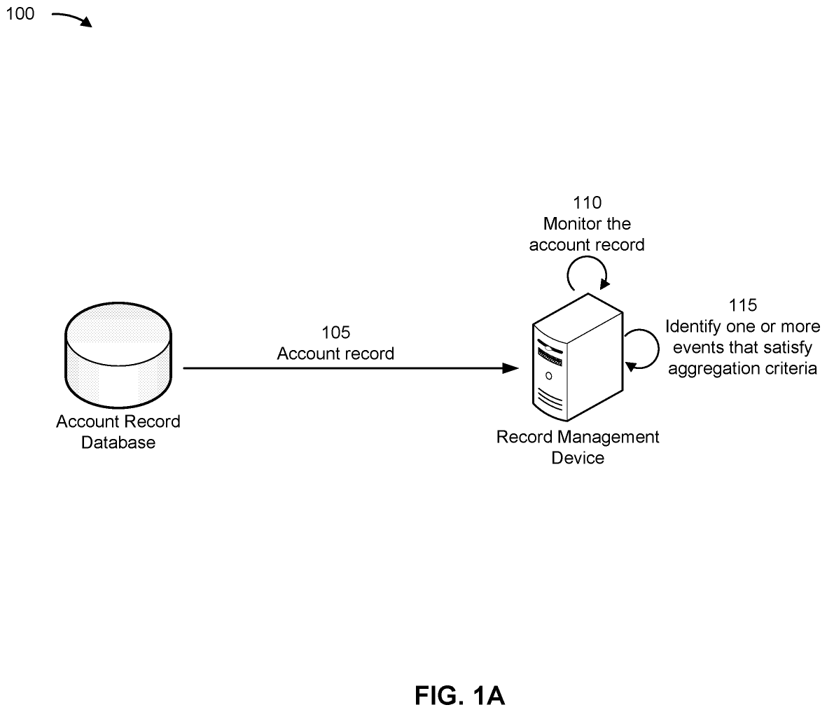

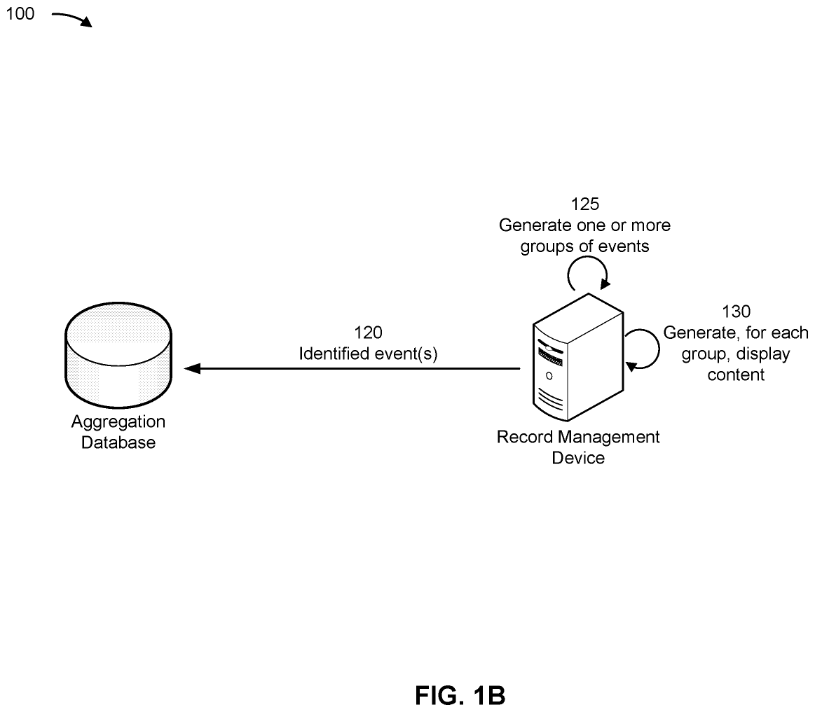

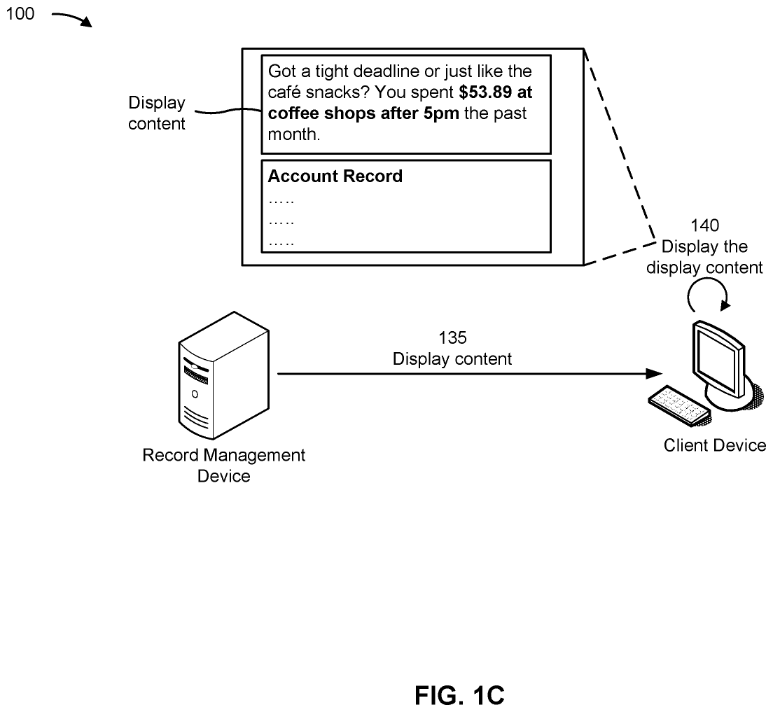

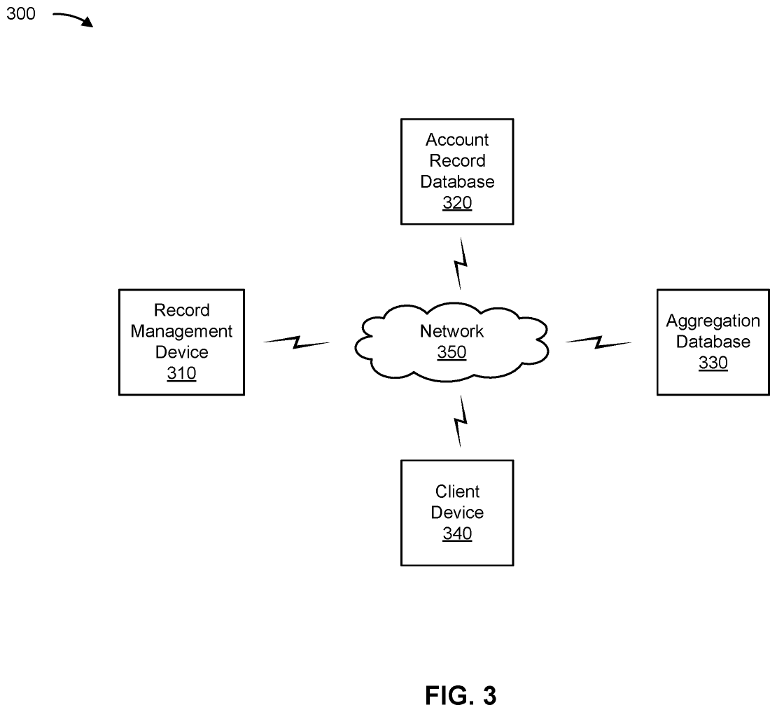

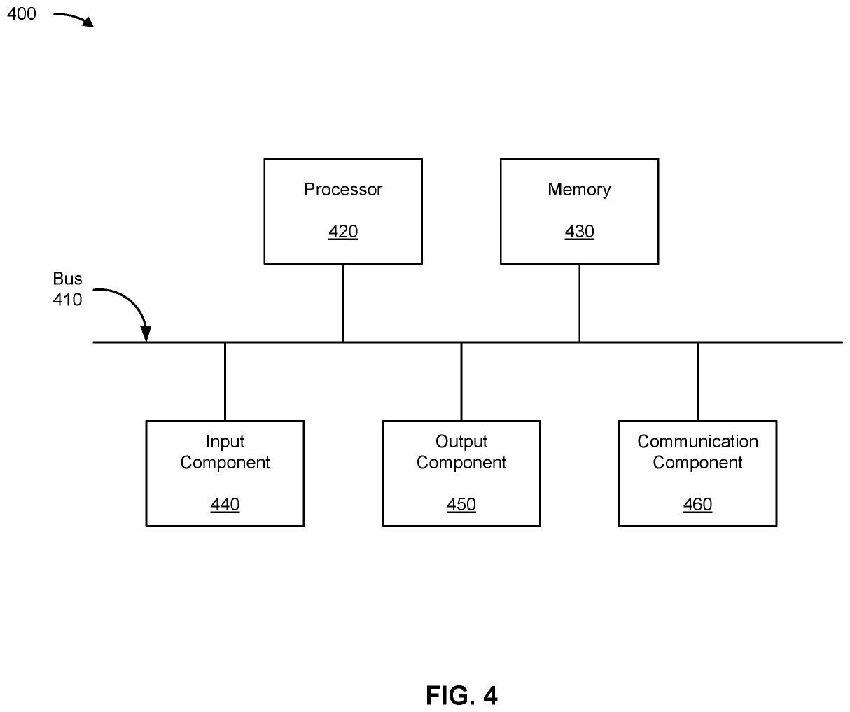

FIGS. 1A-1C are diagrams of an example 100 associated with compiling and generating display content for events in a record. As shown in FIGS. 1A-1C, example 100 includes a record management device, an account record database, an aggregation database, and a client device. These devices are described in more detail in connection with FIGS. 3 and 4.

As described herein, a user may interact with the client device to view information associated with an account. The account may be a financial account, a bank account, a credit card account, or another type of account. The account may be associated with a record. The record may be a list, a statement, a database, and/or a data structure, among other examples. For example, the record may be a transaction record, a financial record, a credit card record, and/or a financial statement (e.g., a bank statement or a credit card statement), among other examples. The record may indicate one or more events associated with the account. As used herein, “event” may refer to an event associated with resources associated with the account. For example, an event may be a transaction, an exchange, an electronic exchange, a sale, and/or a transfer, among other examples. For example, “event” and “transaction” may be used interchangeably herein.

As shown in FIG. 1A, and by reference number 105, the record management device may obtain an account record associated with an account. For example, the record management device may obtain the account record from the account record database. In some implementations, the record management device may periodically obtain the account record, such as every X days, once each week, once each month, and/or according to another periodic schedule. Additionally, or alternatively, the record management device may continually monitor the account record. The account record database may store account records for one or more accounts.

For example, as shown by reference number 110, the record management device may monitor the account record. The record management device may monitor the account record in real time to identify events as they are added to the account record. For example, the record management device may be configured to detect new events added to the account record (e.g., in real time). For example, the record management device may employ a real-time monitoring system configured to continuously process and analyze incoming events associated with the account record (e.g., within a dynamic data stream). The monitoring system may utilize a combination of hardware and software components to ensure seamless and efficient monitoring. Utilizing high-speed data ingestion, the record management device can quickly capture and standardize incoming events associated with the account record. The monitoring system may enable the record management device to trigger alerts, initiate workflows, and/or update statistics based on detected events, while also leveraging machine learning models to adaptively identify emerging trends or potential fraud associated with the account record, as described in more detail elsewhere herein.

As shown by reference number 115, the record management device may identify one or more events, indicated by the account record, that satisfy one or more aggregation criteria. For example, the record management device may aggregate, based on monitoring the account record, one or more events from a set of events (e.g., included in the account record) that satisfy the one or more aggregation criteria. In some implementations, the record management device may identify the one or more events based on account data associated with the account record and/or event data associated with the set of events, among other examples. For example, the account data may indicate a type or category of events that are to be identified and/or aggregated. For example, the account data may indicate the one or more aggregation criteria.

Event data may be data associated with one or more events (e.g., one or more transactions). For example, event data may include an event type (e.g., a transaction type), an amount (e.g., a transaction amount), a date, a location, a payment method, an account identifier, product/service data (e.g., information about items or services associated with an event), an event identifier, and/or an entity associated with the account (e.g., a merchant), among other examples.

In some implementations, the record management device may aggregate the one or more events, indicated by the account record, that satisfy one or more aggregation criteria in accordance with a periodic schedule. For example, the record management device may aggregate the one or more events, indicated by the account record, that satisfy one or more aggregation criteria on a weekly schedule (e.g., aggregating events from a previous week), a monthly schedule (e.g., aggregating events from a previous month), and/or a yearly schedule (e.g., aggregating events from a previous year), among other examples.

Additionally, or alternatively, the record management device may aggregate the one or more events, indicated by the account record, that satisfy one or more aggregation criteria based on detecting an aggregation trigger. The aggregation trigger may be based on activity associated with the account. For example, the aggregation trigger may be associated with a trip or travel. For example, the record management device may detect, based on activity associated with the account, that the user is traveling or on a trip. The record management device may aggregate the one or more events, indicated by the account record, that satisfy one or more aggregation criteria based on detecting that the user is traveling or on a trip (e.g., where event(s) associated with the travel or the trip or aggregated).

In some implementations, the one or more aggregation criteria may indicate that events associated with one or more criteria are to be identified and/or aggregated. For example, the criteria may include events that are recurring non-pattern-based events (e.g., recurring non-subscription-based events), associated with a trip (e.g., that occur at or near a given location, where a distance between the given location and a home location associated with the account satisfies a distance threshold), associated with new entities for the account (e.g., an event associated with an entity for which no other events are associated), and/or associated with new event types for the account, among other examples.

For example, an aggregation criterion may include a recurring non-subscription event criterion. In such examples, the record management device may identify recurring non-subscription-based events from the set of events associated with the account record. For example, a recurring non-subscription-based event may include events that are associated with the same entity and/or event type, but that are not associated with an identifiable pattern or trend. As an example, the record management device may identify the recurring non-subscription-based event(s) based on the one or more events being associated with an entity or event type that is associated with multiple events from the set of events. Additionally, the record management device may identify the recurring non-subscription-based event(s) based on the one or more events being separately initiated (e.g., not initiated via a single transaction or a single request). Additionally, the record management device may identify the recurring non-subscription-based event(s) based on the one or more events being user initiated events.

For example, subscription-based events and user-initiated events may have distinct attributes that differentiate subscription-based events from user-initiated events. For subscription-based events, if event data associated with the event includes a subscription identifier, renewal dates, and/or subscription plan details, among other examples, then this may be indicative of the event being a subscription-based event. Alternatively, if event data associated with the event includes a unique identifier associated with specific products or services, then then this may be indicative of the event being a user-initiated event. As another example, event data for a given event may include metadata that provides context associated with the given event. The metadata may include information about an origin, a user account, and/or timestamp, among other examples. The metadata for subscription-based events may indicate an automated billing cycles, whereas metadata for user-initiated events may indicate more varied timestamps and associated actions.

In some implementations, the record management device may identify a recurring non-subscription-based event based on one or more keywords associated with a record of the event. For example, a keyword may be indicative that the event is a recurring non-subscription-based event. As an example, a keyword may indicate that the event is recurring. For example, certain types of events may be more likely to be recurring events. The record management device may identify a type of event that is more likely to be a recurring event based on one or more keywords included in the record of the event.

Identifying the recurring non-subscription-based events may enable the record management device to generate more insightful content for events associated with the account record that occur frequently, but that are not associated with a subscription or set pattern. For example, recurring non-subscription-based events may be otherwise difficult to identify from the account record (e.g., when viewed by the user) because the recurring non-subscription-based events are not associated with a given subscription, a common identifier, or a set pattern. Therefore, by identifying and/or aggregating the recurring non-subscription-based events, the record management device may be enabled to generate information for the recurring non-subscription-based events (e.g., which may be of interest to the user and/or provide more insightful account record information) and/or cause the information to be displayed.

In some implementations, the record management device may determine that an event satisfies or meets an aggregation criterion based on detecting that the one or more events are associated with a subscription. For example, the record management device may aggregate subscription based events and recurring non-subscription-based events.

As another example, the record management device may determine that an event satisfies or meets an aggregation criterion based on detecting that the one or more events are associated with a trigger category. For example, the record management device may detect, based on event data associated with an event, that the event is associated with a trigger category. A trigger category may include a travel category, a new event type category, and/or another type of category. The record management device may identify the one or more events based on detecting that the one or more events are associated with the trigger category.

For example, an aggregation criterion may include a trip criterion (e.g., for events associated with a travel category). The record management device may identify the one or more events based on the one or more events being associated with a trip or a travel event. For example, the record management device may detect a trip or travel event based on determining that there are a threshold quantity of events in a location (e.g., an area or geographic region) where a distance between the location and a home location associated with the account satisfies a distance threshold, and where the events occur within a certain amount of time from each other. Based on detecting the trip or travel event, the record management device may aggregate all events associated with the trip or travel event.

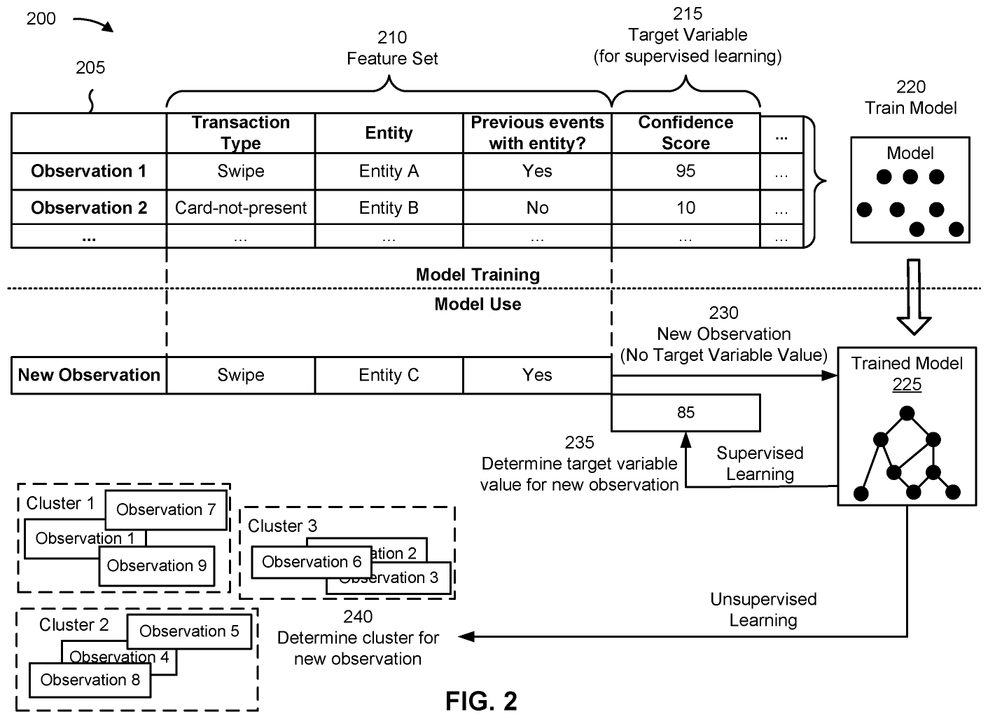

In some implementations, the record management device may identify, using a machine learning model, the one or more events (e.g., that satisfy or meet the one or more aggregation criteria) from the set of events included in the account record. For example, the record management device may obtain, via the machine learning model, confidence scores for respective events from the set of events. The confidence scores may indicate likelihoods that the respective events are recurring non-subscription-based events. The record management device may determine that the one or more events are the recurring non-subscription-based events based on the one or more events being associated with respective confidence scores, from the confidence scores, that satisfy a confidence threshold. The training and use of the machine learning model is depicted and described in more detail in connection with FIG. 2.

As shown in FIG. 1B, and by reference number 120, the record management device may store, in the aggregation database, the identified event(s). For example, the record management device may store, based on identifying the one or more events, an indication of the one or more events in the aggregation database. For example, the record management device may identify the one or more events (e.g., that satisfy or meet the one or more aggregation criteria) from the set of events included in the account record, as described elsewhere herein. The record management device may extract information associated with the one or more events (e.g., event data) and store the information in a separate database and/or storage location from the account record (e.g., the record management device may store the information in the aggregation database).

As shown by reference number 125, the record management device may generate one or more groups of events. The record management device may generate the one or more groups based on one or more event parameters. An event parameter may refer to an attribute, characteristic, class, category, and/or other parameter associated with one or more events (e.g., associated with one or more transactions). In some implementations, an event parameter may include a score indicating a likelihood that an event is associated with a given event parameter. As an example, an event parameter may include an entity similarity score (e.g., indicating whether two or more entities are similar), and/or an event type score (e.g., indicating a likelihood that an event is associated with a given event type or event category), among other examples. As another example, an event parameter may include an event time parameter (e.g., indicating a time, day, and/or date at which an event occurs), an event amount parameter (e.g., indicating an amount or transaction total associated with an event), and/or an event location parameter (e.g., indicating a physical location, geographic location, and/or geographic region at which an event occurs), among other examples. The record management device may generate, based on the event data associated with respective identified events, one or more groups of events, from the one or more identified events, indicating events associated with respective event parameters. In other words, a given group may be associated with a given event parameter (and/or a given value or string of the given event parameter).

In some implementations, the record management device may identify one or more event parameters using one or more keywords included in a record of a given event. For example, the record may include one or more keywords that describe the event. The record management device may use the one or more keywords to determine one or more event parameters for the event. As another example, the record management device may use application data to determine one or more event parameters for a given event. For example, a record for an event may indicate that the event is associated with (e.g., is conducted via) a food delivery service. However, the record may not indicate what the event was for (e.g., a particular type of food or a restaurant from which food was purchased). The record management device may obtain application data (e.g., via an application for the food delivery service, as an example) that indicates one or more event parameters for the event. Using the food delivery service example, the application data may indicate a restaurant from which food was purchased and/or what particular items were purchased.

As another example, the record management device may use receipt data to determine one or more event parameters for a given event. The record management device may obtain the receipt data via a digital receipt and/or an image of a physical receipt. The receipt data may indicate a merchant and/or one or more items that were obtained via a given event. Additionally, the receipt data may indicate amounts for respective items associated with the given event. This may enable the record management device to aggregate data on a more granular level (e.g., on an item level, rather than an event level).

The record management device may generate the one or more groups using a machine learning model, such as described in more detail in connection with FIG. 2. In some examples, the record management device may generate the one or more groups using a clustering model. The record management device may cluster (e.g., using the clustering model) the identified events into one or more clusters based on clustering information (e.g., based on vector quantization information or other information). For example, the record management device may process the event data associated with the identified events to obtain clustering information associated with the event data. The clustering information may include vector quantization information. For example, the record management device may process the event data to obtain vector quantization information associated with the event data. For example, the compliance device may initialize the event data by selecting K data points from the input data as initial centroids. The K data points may be randomly selected or may be defined (e.g., via a user input) for training the clustering model. As an example, initial centroids may be defined for respective event parameters (or a given value or string of the given event parameter), as described in more detail elsewhere herein.

The record management device may assign each data point in the input data to the nearest centroid (e.g., from the K initial centroids) based on a distance metric. The distance metric may be a Euclidean distance or another distance metric. The record management device may update the centroid for each cluster (e.g., by calculating the mean of the data points assigned to each cluster) to create a new centroid that is closer to the center of each respective cluster. The record management device may iteratively assign data points to respective clusters followed by updating the centroid for each cluster until a convergence event occurs and/or is detected. The convergence event may include the centroids no longer changing during the updating step, or a predetermined quantity of iterations being performed, among other examples. An output of the clustering model may include one or more event parameter clusters and data points (e.g., events) clustered into respective event parameter clusters. The event parameter clusters may be associated with respective event parameters. For example, the one or more clusters may be indicative of respective types of events and/or event parameters.

As an example, the event parameter may be associated with an entity type. The entity may be associated with the event. For example, the entity may be a merchant, business, or seller associated with a transaction. The record management device may group events that are associated with similar entities. As an example, similar entities may be entities that offer similar products or services for sale. For example, the record management device may evaluate and/or compare two or more entities engaged in commercial activities to ascertain the degree of resemblance and commonality between the two or more entities. For example, the record management device may analyze various factors that contribute to business operations of an entity, industry affiliations, customer interactions, and/or overall business strategies, among other examples.

For example, the record management device may determine, for entities associated with respective events from the one or more identified events (e.g., indicated via information stored in the aggregation database), one or more entity similarity scores indicating a similarity between two or more entities. For example, the record management device may determine the one or more entity similarity scores based on category code information associated with the entities. For example, entities operating within the same industry sector often share similar products, services, and/or market dynamics, among other examples. The industry sector may be defined by standardized industry classification systems, such as a North American industry classification system (NAICS) code, a standard industrial classification (SIC) code, a merchant category code, and/or another type of classification system.

Additionally, or alternatively, the record management device may determine the one or more entity similarity scores based on product and/or service offerings (e.g., similar entities often offer comparable ranges of products or services), a geographic location, a business model (e.g., comparing business models, such as whether an entity operates as a brick-and-mortar store, an e-commerce platform, or a subscription service, can help identify similarities in operational approaches), and/or a customer base (e.g., entities with similar target demographics, customer profiles, and purchasing behavior may similar), among other examples. For example, the record management device may determine an entity similarity score based on a comprehensive analysis of various factors that contribute to the shared characteristics and operational practices between two or more entities.

The record management device may generate, based on the one or more entity similarity scores, one or more groups of events indicating events associated with similar entities. For example, a given group may be associated with a given entity type. As an example, an entity type may include coffee shops, grocery stores, sporting goods stores, e-commerce platforms, clothing stores, restaurants, electronics stores, home improvement stores, and/or pet stores, among other examples. The record management device may determine for entities associated with respective events from the one or more identified events, one or more entity similarity scores indicating similarities between two or more entities. The record management device may group an event, from the one or more events, into the group of events based on an entity similarity score associated with the event indicating that the event is associated with an entity that is associated with the group of events. In other words, the record management device may cluster (e.g., via the clustering model) an event into a group based on an entity (e.g., a merchant) associated with the event being similar to other entities associated with the group.

As another example, the event parameter may include an event type. The event type may include a trip event type (e.g., for events associated with a given trip or travel occurrence), a new entity event type (e.g., for events associated with a new entity for the account), a timing event type (e.g., for events associated with a given time, a given range of times, and/or a given day), and/or another event type. The record management device may determine respective event type scores associated with the one or more events (e.g., may determine one or more event type scores for each identified event). The respective event type scores may indicate a likelihood that the one or more events are associated with an event type (e.g., an event type may be associated with a group of events, such as events associated with a trip or vacation, events associated with a certain timing, or events associated with another event type). The record management device may group an event, from the one or more identified events, into the group of events based on an event type score associated with the event indicating that the event is associated with the event type. In other words, the record management device may cluster (e.g., via the clustering model) an event into a group based on an entity type associated with the event being similar to other events associated with the group.

Generating the one or more groups may enable the record management device to obtain information associated with events (e.g., that are associated with the account) that may not otherwise be easily identifiable via an account summary or by viewing the account record. For example, the groups enable the record management device to extract trends, habits, patterns, and/or other information associated with events of the account that are not subscription based or associated with a defined pattern. This enables the record management device to generate more insightful and/or usable information for a user associated with the account, as described in more detail elsewhere herein.

As shown by reference number 130, the record management device may generate, for each group, display content. In some implementations, the record management device may generate the display content based on detecting a trigger. For example, the trigger may include obtaining a request to view or access the account record. For example, a user interface associated with viewing the account may include a page associated with viewing the account record. The trigger may include the record management device obtaining an indication (e.g., via the client device) that the page is being opened via the user interface. As another example, the user interface may include an option to view an account summary. The trigger may include the record management device obtaining an indication (e.g., via the client device) that the account summary is requested via an input to the user interface. Additionally, or alternatively, the record management device may periodically generate the display content and may provide (e.g., to the client device) the display content in response to detecting the trigger.

The record management device may generate, for a group of events from the one or more groups of events, display content indicative of information associated with events included in the group. The display content may be based on the information associated with the events included in the group and/or may be based on the account data associated with the account. For example, the account data may include an indication of one or more event types to be indicated via the display content, one or more content types to be indicated via the display content, and/or a content class (e.g., a ridicule level, a subtext type, a tone, and/or another content class) to be associated with the display content, among other examples.

For example, the content class may indicate a subtext, nuance, implicit or hidden semantic meaning, a tone, and/or an undertone, among other examples of the display content. The content class may be based on account data associated with the account. For example, the content class may include a ridicule level. For example, the ridicule level may indicate a level of mocking or ridicule indicated by the display content. For example, the display content may be satirical and/or sarcastic to mock, tease, and/or ridicule the user of the account based on information of event(s) included in a given group. For example, generating display content having a ridicule level may enable the record management device to generate display content that is more engaging and/or insightful as compared to other types of content due to psychological, social, and/or cognitive factors that contribute to the effectiveness of content that is satirical and/or sarcastic. For example, humor may trigger positive emotions, such as laughter and/or amusement, that may create an immediate emotional connection between the content and the user. As another example, generating display content having a ridicule level may enable the record management device to generate display content that utilizes rhetorical techniques to simplify complex concepts indicated by the account record, thereby making the complex concepts more accessible and/or easier to understand (e.g., a user may be more likely to understand intricate information presented within a humorous context).

However, incorporating humor into content design requires understanding the preferences and/or cultural sensitivities of the user associated with the account. In some implementations, the record management device may determine a content type, a content class, and/or an event type to be indicated via the display content based on user interaction information associated with historical display content provided for the account record. For example, the user interaction information may include whether the user shared the historical display content to another platform or device. If the user previously shared historical display content having a given content type, content class, and/or event type, then the record management device may determine that the user wants the given content type, content class, and/or event type to be indicated via future display content. As another example, the user interaction information may include an indication that the user has complained about, reported, and/or no longer wishes to see historical display content having a given content type, content class, and/or event type. This may be indicative that the user does not want the given content type, content class, and/or event type to be indicated via future display content. The user interaction information may enable the record management device to gain insight into the preferences and/or cultural sensitivities of the user associated with the account to facilitate the generation of more personalized and/or engaging display content.

For example, the record management device may determine a ridicule level to be associated with the display content based on the account data and/or the user interaction information. The record management device may determine the display content based on the ridicule level. For example, the record management device may determine the display content to be indicative of information for event(s) included in the group and to also have the ridicule level, undertone, and/or subtext, indicated by a determined content class associated with the display content.

In some implementations, the record management device may generate the display content via a large language model. For example, the record management device may provide, to the large language model, the information associated with the events included in the group and an indication of the content class. For example, the record management device may provide, to the large language model, the ridicule level and the information associated with the events included in the group. The record management device may obtain, via the large language model, the display content. For example, in response to providing the information associated with the events included in the group and an indication of the content class, the large language model may output the display content.

As another example, the record management device may generate the display content using one or more content templates. For example, the one or more content templates may be associated with respective content types and/or content classes. The record management device may determine the content type and/or the content class associated with the display content based on the account data and/or based on the group. For example, the content type may be based on the group (e.g., a group may be associated with a given entity type and the content type may be associated with indicating information for the given entity type).

The record management device may determine and/or generate the display content using a content template from a set of content templates that are associated with the content type and/or the content class. For example, the record management device may identify the content template based on the information associated with the events included in the group. For example, the information may be indicative of a trend, pattern, and/or habit, among other examples. The content template may be associated with indicating information for the trend, pattern, and/or habit. For example, the information may be indicative of a high quantity of events in a given time period. The content template may be associated with indicating high quantity of events. As another example, the information may be indicative of a lesser quantity of events in a given time period as compared to previous time periods. The content template may be associated with indicating a decreasing quantity of events over time.

The record management device may determine and/or generate the display content by modifying one or more modifiable fields in the content template to indicate the information associated with the events. For example, a content template may include one or more modifiable fields and/or fixed information. As an example, a content template may include “Wow, you've spent [field 1] at [field 2] this year. That's [field 3] of all your spending for your account(s). We know [field 2] is great, but ouch your wallet!” In such examples, [field 1], [field 2], and [field 3] may be modifiable fields. For example, [field 1] may be a field for inserting a total amount of the event(s) included in the group (e.g., a total transaction amount summed from all events in the group), [field 2] may be a field for inserting an entity or an entity type associated with the group, and [field 3] may be a field for inserting a percentage or ratio of the value of [field 1] to the total amount spent for all events associated with the account (e.g., over a given time period).

As another example, a content template may include “you spent [field 1] [more or less] at [field 2] during the summer!” In such examples, [field 1] may be a field for inserting a difference between a total amount of the event(s) included in the group during a given time period and a total amount of the event(s) included in the group during another time period. The [more or less] may be a field for which the record management device selects a value based on the value of [field 1]. For example, if [field 1] indicates an increased amount as compared to previous time periods, then the record management device may select “more,” whereas if [field 1] indicates a decreased amount as compared to previous time periods, then the record management device may select “less.” The [field 2] may be a field for inserting an entity or an entity type associated with the group.

As another example, a content template may include “You visited [field 1] new restaurants this year! [Field 2] seemed to be your new favorite.” In such examples, the [field 1] may be a field for inserting a quantity of entities indicated by events included in the group (e.g., where the group is associated with events associated with new entities). The [field 2] may be a field for inserting an entity name that is associated with the most events from the events included in the group.

The record management device may determine information to be inserted into the modifiable field(s) based on information associated with the event(s) included in the group. The display content may include the content template with the one or more modifiable fields indicating the information associated with the events. As a result, the record management device may generate display content having a given content class (e.g., a subtext, nuance, implicit or hidden semantic meaning, a tone, and/or an undertone). This may improve a likelihood that the user may be more likely to read, understand, and/or digest the display content. This enables the user to quickly locate informational content of interest for the account record without navigating away from a user interface associated with the account record and without interacting with numerous links or graphical elements from the user interface, thereby conserving processing resources and/or network resources, as described in more detail elsewhere herein.

In some implementations, the record management device may determine a redeemable offer for an entity that is associated with the display content. For example, the redeemable offer may include a discount, a sale, an exclusive offer, or another type of offer. As an example, the entity may provide the redeemable offer for users associated an institution that manages or provides the account. The record management device may generate the display content to indicate the redeemable offer and/or to include a link or graphical element to enable the redeemable offer to be redeemed. As another example, the record management device may determine one or more recommended entities based on the display content. For example, the record management device may determine one or more recommended entities based on the group that is associated with the display content.

As shown in FIG. 1C, and by reference number 135, the record management device may provide, for display in association with the account record, the display content. For example, the record management device may provide or transmit, and the client device may obtain or receive, the display content for display via the client device (e.g., in association with displaying the account record).

For example, the record management device may transmit, and the client device may receive, display information for a user interface that is associated with displaying the account record or a summary page associated with the account record. The display information may include information to cause the display content to be displayed in association with the account record via the user interface.

As shown by reference number 140, the client device may display the display content (e.g., via the user interface). For example, as shown in FIG. 1C, the user interface may include the account record and the display content. In other examples, the user interface may include only the display content. For example, the display content may be “Got a tight deadline or just like the café snacks? You spent $53.89 at coffee shops after 5 pm the past month.” The italicized content (e.g., the bolded content as shown in FIG. 1C) in the display content may be based on one or more events included in a group that is associated with an entity type of coffee shops. For example, the record management device may analyze event data from the one or more events included in the group to determine that a total amount spent at coffee shops after 5 μm in the past month is $53.89. As another example, the display content may be “Having some fun in the sun? You spent $458.75 on your trip to Florida.” The italicized content in the display content may be based on one or more events included in a group that is associated with a trip or vacation. The record management device may analyze event data from the one or more events included in the group to determine that a total amount spent is $458.75. Additionally, the record management device may analyze event data from the one or more events included in the group to determine that a location of the trip or vacation is Florida.

In some implementations, the record management device may provide, for display in association with the display content, one or more recommended entities that are determined based on the information associated with the events, as described in more detail elsewhere herein. In some implementations, the record management device may provide, for display in association with the display content, a redeemable offer for an entity that is associated with the display content. The client device may display the redeemable offer in connection with the display content. In some implementations, the client device may obtain a user input (e.g., via the user interface) indicating an acceptance of the redeemable offer. The client device may provide, and the record management device may obtain, an indication of an acceptance of the redeemable offer.

In some implementations, the record management device may cause, based on obtaining the indication of the acceptance, the redeemable offer to be applied to the account. For example, the redeemable offer may be for a discount at a given entity. The record management device may cause the discount to be applied to the account and/or may cause a discount code to be provided to the user associated with the account (e.g., via an email communication, a text message, or another communication). This may reduce an amount of navigation that is needed to be performed by the user to identify, obtain, and/or apply the redeemable offer. For example, the user is enabled quickly locate a redeemable offer of interest without navigating away from a user interface associated with the account record and without interacting with numerous links or graphical elements from the user interface. In this way, processing resources, computing resources, and/or network resources may be conserved by reducing the amount of navigation performed by the user to obtain the redeemable offer of interest.

As indicated above, FIGS. 1A-1C are provided as an example. Other examples may differ from what is described with regard to FIGS. 1A-1C.

FIG. 2 is a diagram illustrating an example 200 of training and using a machine learning model in connection with compiling and generating display content for events in a record. The machine learning model training and usage described herein may be performed using a machine learning system. The machine learning system may include or may be included in a computing device, a server, and/or a cloud computing environment, among other examples, such as the record management device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the client device, the account record database, and/or the aggregation database, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the client device, the account record database, and/or the aggregation database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of transaction type (e.g., payment method), a second feature of Entity (e.g., entity name), a third feature of whether previous events (e.g., associated with an account record) are associated with the entity, and so on. As shown, for a first observation, the first feature may have a value of “Swipe,” the second feature may have a value of “Entity A,” the third feature may have a value of “Yes,” and so on. These features and feature values are provided as examples, and may differ in other examples. For example, the feature set may include one or more of the following features: an amount (e.g., a transaction amount), a date, a location, an account identifier, product/service data (e.g., information about items or services associated with an event), an event identifier, billing cycle data, a subscription identifier, one or more renewal dates, subscription plan data, whether the event is associated with a unique identifier, and/or whether the event is user initiated, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a confidence score, which has a value of 95 for the first observation. For example, the confidence score may indicate a likelihood that a given event is a recurring non-subscription-based event, as described in more detail elsewhere herein (e.g., where a higher value indicates a higher likelihood). In other implementations, the confidence score may indicate a likelihood that a given event is associated with a given event parameter.

The feature set and target variable described above are provided as examples, and other examples may differ from what is described above. For example, for a target variable of entity type, the feature set may include (e.g., for a given event), an entity name, an entity description, an indication of items or services provided by the entity, and/or a code (e.g., a merchant category code or another code) associated with the entity, among other examples. As another example, for a target variable of a confidence score indicating a likelihood that an event is associated with a trip or vacation, the feature set may include a home location associated with the account, a distance between the home location and a location associated with the event, and/or a quantity of events that have occurred within a threshold distance from the location associated with the event, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, and/or a support vector machine algorithm, among other examples. After training, the machine learning system may store the machine learning model as a trained machine learning model 225 to be used to analyze new observations.

As an example, the machine learning system may obtain training data for the set of observations based on historical events or historical transactions associated with one or more accounts. For example, the record management device may obtain historical (and/or anonymized) event data for one or more events (e.g., associated with one or more accounts). The historical event data may be used as the training data for the set of observations.

As shown by reference number 230, the machine learning system may apply the trained machine learning model 225 to a new observation, such as by receiving a new observation and inputting the new observation to the trained machine learning model 225. As shown, the new observation may include a first feature of transaction type, a second feature of entity, a third feature of whether previous events (e.g., associated with an account record) are associated with the entity, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 85 for the target variable of confidence score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, that the event is associated with a recurring non-subscription-based event. The first automated action may include, for example, to cause event data associated with the event to be stored in a database (e.g., the aggregation database).

As another example, if the machine learning system were to predict a value of 15 for the target variable of confidence score, then the machine learning system may provide a second (e.g., different) recommendation (e.g., that the event is not associated with a recurring non-subscription-based event) and/or may perform or cause performance of a second (e.g., different) automated action (e.g., to refrain from storing event data associated with the event in the database).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., associated with a first event parameter), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above. As another example, if the machine learning system classifies the new observation in a first cluster (e.g., associated with a first event parameter), then the machine learning system may provide a first recommendation, such as recommending a type of display content and/or a content template that is associated with the first event parameter. Additionally, or alternatively, the machine learning system may perform a first automated action and/or may cause a first automated action to be performed (e.g., by instructing another device to perform the automated action) based on classifying the new observation in the first cluster, such as generating display content using the type of display content and/or a content template that is associated with the first event parameter.

As another example, if the machine learning system were to classify the new observation in a second cluster (e.g., associated with a second event parameter), then the machine learning system may provide a second (e.g., different) recommendation (e.g., recommending a type of display content and/or a content template that is associated with the second event parameter) and/or may perform or cause performance of a second (e.g., different) automated action, such as generating display content using the type of display content and/or a content template that is associated with the second event parameter.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. For example, the recommendations associated with the event being a recurring non-subscription-based event may include recommending a type of display content and/or a content template that is based on event data associated with the event. The actions associated with causing event data associated with the event to be stored in the database may include, for example, generating display content for a group or cluster of events in which the event data is included (e.g., in the database). The clusters associated with different event parameters may include, for example, clusters associated with respective entity types, one or more clusters associated with respective trips or vacations, and/or one or more clusters associated with events associated with new entities, among other examples.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include user interaction information associated with display content that is provided for display (e.g., where the display content includes information that is based at least in part on event data associated with the event).

In this way, the machine learning system may apply a rigorous and automated process to compile and generate display content for events in an account record. The machine learning system may enable recognition and/or identification of tens, hundreds, thousands, or millions of features and/or feature values for tens, hundreds, thousands, or millions of observations, thereby increasing accuracy and consistency and reducing delay associated with compiling and generating display content for events in the account record relative to requiring computing resources to be allocated for tens, hundreds, or thousands of operators to manually compile and generate display content for events in the account record using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a record management device 310, an account record database 320, an aggregation database 330, a client device 340, and a network 350. Devices of environment 300 may interconnect via wired connections, wireless connections, or a combination of wired and wireless connections.

The record management device 310 may include one or more devices capable of receiving, generating, storing, processing, providing, and/or routing information associated with compiling and generating display content for events in a record, as described elsewhere herein. The record management device 310 may include a communication device and/or a computing device. For example, the record management device 310 may include a server, such as an application server, a client server, a web server, a database server, a host server, a proxy server, a virtual server (e.g., executing on computing hardware), or a server in a cloud computing system. In some implementations, the record management device 310 may include computing hardware used in a cloud computing environment.

The account record database 320 may include one or more devices capable of receiving, generating, storing, processing, and/or providing information associated with compiling and generating display content for events in a record, as described elsewhere herein. The account record database 320 may include a communication device and/or a computing device. For example, the account record database 320 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the account record database 320 may store one or more account records, as described elsewhere herein.

The aggregation database 330 may include one or more devices capable of receiving, generating, storing, processing, and/or providing information associated with compiling and generating display content for events in a record, as described elsewhere herein. The aggregation database 330 may include a communication device and/or a computing device. For example, the aggregation database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the aggregation database 330 may store information of identified events from the record (e.g., identified by the record management device 310), as described elsewhere herein.

The client device 340 may include one or more devices capable of receiving, generating, storing, processing, and/or providing information associated with compiling and generating display content for events in a record, as described elsewhere herein. The client device 340 may include a communication device and/or a computing device. For example, the client device 340 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with compiling and generating display content for events in a record. The device 400 may correspond to the record management device 310, the account record database 320, the aggregation database 330, and/or the client device 340. In some implementations, the record management device 310, the account record database 320, the aggregation database 330, and/or the client device 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

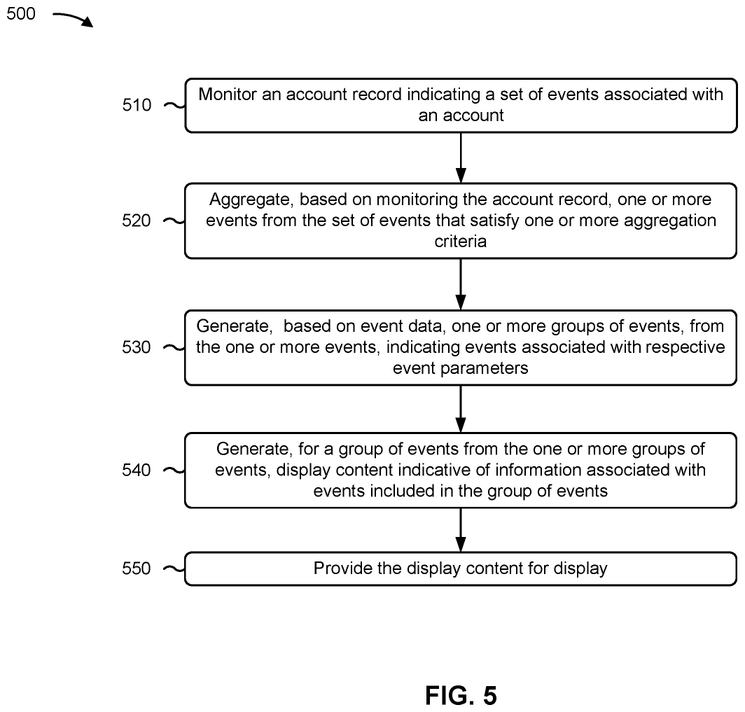

FIG. 5 is a flowchart of an example process 500 associated with compiling and generating display content for events in a record. In some implementations, one or more process blocks of FIG. 5 may be performed by the record management device 310. In some implementations, one or more process blocks of FIG. 5 may be performed by another device or a group of devices separate from or including the record management device 310, such as the account record database 320, the aggregation database 330, and/or the client device 340. Additionally, or alternatively, one or more process blocks of FIG. 5 may be performed by one or more components of the device 400, such as processor 420, memory 430, input component 440, output component 450, and/or communication component 460. Additionally, or alternative, one or more process blocks of FIG. 5 may be performed via the machine learning model depicted and described in connection with FIG. 2.

As shown in FIG. 5, process 500 may include monitoring an account record indicating a set of events associated with an account (block 510). For example, the record management device 310 (e.g., using processor 420 and/or memory 430) may monitor an account record indicating a set of events associated with an account, as described above in connection with reference number 110 of FIG. 1A. As an example, the set of events may be a set of transactions.

As further shown in FIG. 5, process 500 may include aggregating, based on monitoring the account record, one or more events from the set of events that satisfy one or more aggregation criteria (block 520). For example, the record management device 310 (e.g., using processor 420 and/or memory 430) may aggregate, based on monitoring the account record, one or more events from the set of events that satisfy one or more aggregation criteria, as described above in connection with reference number 115 of FIG. 1A. In some implementations, the one or more events are identified based on account data associated with the account record and event data associated with the set of events. As an example, the record management device 310 may aggregate events that that are associated with recurring non-subscription-based events.

As further shown in FIG. 5, process 500 may include generating, based on the event data, one or more groups of events, from the one or more events, indicating events associated with respective event parameters (block 530). For example, the record management device 310 (e.g., using processor 420 and/or memory 430) may generate, based on the event data, one or more groups of events, from the one or more events, indicating events associated with respective event parameters, as described above in connection with reference number 125 of FIG. 1B. As an example, the record management device 310 may group events together that are associated with similar event parameters, such as similar entity types, similar event types, or other event parameters.

As further shown in FIG. 5, process 500 may include generating, for a group of events from the one or more groups of events, display content indicative of information associated with events included in the group of events (block 540). For example, the record management device 310 (e.g., using processor 420 and/or memory 430) may generate, for a group of events from the one or more groups of events, display content indicative of information associated with events included in the group of events, as described above in connection with reference number 130 of FIG. 1B. In some implementations, the display content is based on the information associated with the events and is based on the account data. As an example, the record management device 310 may determine a content class or a content template associated with the display content based on the account data (e.g., based on account preferences and/or user interaction information associated with historical display content). The record management device 310 may generate the display content such that the display content is associated with the content class and/or uses the content template.

As further shown in FIG. 5, process 500 may include providing the display content for display (block 550). For example, the record management device 310 (e.g., using processor 420 and/or memory 430) may provide the display content for display, as described above in connection with reference number 135 of FIG. 1C. As an example, the record management device 310 may provide the display content for display by the client device 340.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a−b, a−c, b−c, and a−b−c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a−b, a−c, b−c, and a−b−c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for compiling and generating display content for events in an account record, the system comprising:
one or more memories; and
one or more processors, communicatively coupled to the one or more memories, configured to:
identify, using a machine learning model, one or more events from a set of events included in the account record, wherein the one or more events are recurring non-subscription-based events, and wherein the one or more events are identified based on account data associated with the account record and event data associated with the set of events;
store, in a database and based on identifying the one or more events, an indication of the one or more events;
determine, for entities associated with respective events from the one or more events, one or more entity similarity scores indicating a similarity between two or more entities;
generate, based on the one or more entity similarity scores, one or more groups of events, from the one or more events, indicating events associated with similar entities;
generate, for a group of events from the one or more groups of events, display content indicative of information associated with events included in the group, wherein the display content is based on the information associated with the events included in the group and is based on the account data; and
provide, for display in association with the account record, the display content.

2. The system of claim 1, wherein the one or more processors, to identify the one or more events, are configured to:
identify the one or more events based on:
the one or more events being associated with an entity or event type that is associated with multiple events from the set of events,
the one or more events being separately initiated, and
the one or more events being user initiated events.

3. The system of claim 1, wherein the one or more processors, to identify the one or more events, are configured to:
obtain, via the machine learning model, confidence scores for respective events from the set of events,
wherein the confidence scores indicate likelihoods that the respective events are the recurring non-subscription-based events; and
determine that the one or more events are the recurring non-subscription-based events based on the one or more events being associated with respective confidence scores, from the confidence scores, that satisfy a threshold.

4. The system of claim 1, wherein the one or more processors, to determine the one or more entity similarity scores, are configured to:
determine the one or more entity similarity scores based on category code information associated with the entities.

5. The system of claim 1, wherein the one or more processors, to generate the display content, are configured to:
determine a ridicule level to be associated with the display content based on the account data; and
determine the display content based on the ridicule level.

6. The system of claim 5, wherein the one or more processors, to generate the display content, are configured to:
provide, to a large language model, the ridicule level and the information associated with the events included in the group; and
obtain, via the large language model, the display content.

7. The system of claim 1, wherein the one or more processors, to identify the one or more events, are configured to:
detect, based on the event data, that the one or more events are associated with a trigger category; and
identify the one or more events based on detecting that the one or more events are associated with the trigger category.

8. The system of claim 7, wherein the trigger category includes at least one of:
a travel category, or
a new event type category.

9. A method of compiling and generating display content for events in an account record, comprising:
monitoring, by a device, the account record, wherein the account record indicates a set of events associated with an account;
aggregating, by the device and based on monitoring the account record, one or more events from the set of events that satisfy one or more aggregation criteria, wherein the one or more events are identified based on account data associated with the account record and event data associated with the set of events;
generating, by the device and based on the event data, one or more groups of events, from the one or more events, indicating events associated with respective event parameters;
generating, by the device and for a group of events from the one or more groups of events, display content indicative of information associated with events included in the group of events, wherein the display content is based on the information associated with the events and is based on the account data; and
providing, by the device, the display content for display.

10. The method of claim 9, wherein the respective event parameters include an entity similarity score, and wherein generating the one or more groups of events comprises:
determining, for entities associated with respective events from the one or more events, one or more entity similarity scores indicating similarities between two or more entities; and
grouping an event, from the one or more events, into the group of events based on an entity similarity score associated with the event indicating that the event is associated with an entity that is associated with the group of events.

11. The method of claim 9, wherein the respective event parameters include an event type score, and wherein generating the one or more groups of events comprises:
determining respective event type scores associated with the one or more events,
wherein the respective event type scores indicate a likelihood that the one or more events are associated with an event type, and
wherein the event type is associated with the group of events; and
grouping an event, from the one or more events, into the group of events based on an event type score associated with the event indicating that the event is associated with the event type.

12. The method of claim 9, wherein generating the display content comprises:
determining a content type associated with the display content based on the account data; and
determining the display content using a content template from a set of content templates that are associated with the content type,
wherein the content template is identified based on the information associated with the events included in the group of events.

13. The method of claim 12, wherein the content template includes one or more modifiable fields, and wherein generating the display content comprises:
modifying the one or more modifiable fields to indicate the information associated with the events,
wherein the display content includes the content template with the one or more modifiable fields indicating the information associated with the events.

14. The method of claim 9, wherein generating the display content comprises:
determining at least one of a content type or an event type to be indicated via the display content based on user interaction information associated with historical display content provided for the account record.

15. The method of claim 9, wherein the one or more aggregation criteria include events that are at least one of:
recurring non-pattern-based events,
associated with a trip,
associated with new entities for the account, or
associated with new event types for the account.

16. The method of claim 9, wherein providing the display content for display comprises:
providing, for display in association with the display content, a redeemable offer for an entity that is associated with the display content;
obtaining an indication of an acceptance of the redeemable offer; and
causing, based on obtaining the indication of the acceptance, the redeemable offer to be applied to the account.

17. A non-transitory computer-readable medium storing a set of instructions, the set of instructions comprising:
one or more instructions that, when executed by one or more processors of a device, cause the device to:
obtain an account record indicating a set of events associated with an account;
aggregate, based on monitoring the account record, one or more events from the set of events based on the one or more events satisfying one or more aggregation criteria;
generate one or more groups of events, from the one or more events, indicating events associated with respective event parameters;
generate, for a group of events from the one or more groups of events, display content indicative of information associated with events included in the group of events, wherein the display content is based on the information associated with the events and is based on account data associated with the account record; and
provide the display content for display.

18. The non-transitory computer-readable medium of claim 17, wherein the respective event parameters include an entity similarity score, and wherein generating the one or more groups of events comprises:
determining, for entities associated with respective events from the one or more events, one or more entity similarity scores indicating a similarity between two or more entities; and
grouping an event, from the one or more events, into the group of events based on an entity similarity score associated with the event indicating that the event is associated with an entity that is associated with the group of events.

19. The non-transitory computer-readable medium of claim 17, wherein the one or more instructions, that cause the device to generate the display content, cause the device to:
determine at least one of a content type associated with the display content based on user interaction information associated with historical display content provided for the account record.

20. The non-transitory computer-readable medium of claim 17, wherein the one or more instructions, that cause the device to provide the display content for display, cause the device to:
provide, for display in association with the display content, one or more recommended entities that are determined based on the information associated with the events.
